(19) United States
(12) Patent Application Publication
(10) Pub. No.: US 2007/0107256 A1
(43) Pub. Date: May 17, 2007

(54) Device and method for drying a treated product

(75) Inventors: Ferdinand Wiener, Burgthann (DE); Uwe Hauf, Wendelstein (DE); Klaus Brehm, Pyrbaum (DE)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Atotech Deutschland GmbH

(21) Appl. No.: 10/575,996

(22) PCT Filed: Oct. 12, 2004
(86) PCT No.: PCT/EP04/11413

§ 371 Date: Nov. 9, 2006

(30) Foreign Application Priority Data
Oct. 17, 2003 (DE) 103 48 351.9

(51) Int. Cl. F26B 3/00

(52) U.S. Cl. 34/497; 34/491; 34/493

(57) ABSTRACT

An apparatus and a corresponding method for drying articles which have been treated (1) are proposed, the apparatus including transport means (3) for transporting the treated articles (1) along a transport path. Gas outlet devices (4, 5) disposed opposite one another are arranged above the transport path. A gaseous drying medium is supplied separately by fan means to the gas outlet apertures by supply lines (8, 9).

A pressure associated with each gas outlet device (4, 5) is detected and a gas flow associated with the gas outlet device (4, 5) is regulated by regulating means as a function of this pressure.

The present invention relates to a method and an apparatus for drying articles that have been treated. In particular, the method according to the invention and the apparatus according to the invention are used for rapid, gentle and uniform drying of, for example, plate-like articles that have been treated, preferably in electroplating or etching installations.

In many wet-chemical, electrolytic or other coating processes drying of the articles that have been treated and to which a coating has been applied is necessary as the last working step of this process. Dryers including a housing into which the treated articles are continuously conveyed and out of which they are conveyed after the drying process are often used for this purpose. A gaseous drying medium such as air is normally used for drying. To increase the drying effect the gaseous drying medium is heated, for example, by heat exchangers or heating cartridges, in which case the housing is generally provided on the outside with heat insulation. The drying medium is supplied to the treated articles via nozzles by means of fans. The drying itself then takes place substantially through evaporation of liquid on a surface of the treated articles. As this happens the drying medium absorbs moisture on the surface of the treated articles until a certain level of saturation has been reached. Drying medium used in this way is then discharged—usually continuously—via adjustable flaps or outlet lines and replaced by unused drying medium.

During the drying process it is important to treat the treated articles, which are frequently delicate, gently, so that no damage occurs. In addition, the drying should take place as uniformly as possible. With heat-sensitive treated articles damage can otherwise occur through local overheating. In the case of treated articles having a soft surface, scratches occurring during transportation of the treated articles through the drier can lead to rejects.

To keep costs as low as possible, the drying should take place in the shortest possible time, although complete drying must be ensured.

Dryers which meet these requirements are used, for example, in horizontal, continuously operating installations for electroplating and etching printed circuit boards. In this case the treated article, which is in the shape of a plate is typically conveyed in a horizontal position and in a horizontal transport direction on rolls or rollers through the drier. For this purpose narrow openings, through which the treated articles move into and out of the drier, are provided in the walls of the housing on the entry and exit sides of the drier. The heated drying medium is generally supplied by means of pressure nozzles which blow the drying medium against the treated article, for example, a printed circuit board.

A drier of this type is described in detail in U.S. Pat. No. 4,017,982. In this drier a so-called air knife, which is claimed to remove a major part of the liquid present on the surface of the treated article by displacement with cold air, is used in addition to the drying through evaporation. In this drier the pressure nozzles are provided with outlet apertures which are so aligned that air is impelled obliquely on to the treated article at an angle ≠90°, so that displacement of the liquid is achieved.

In other apparatuses the air is supplied by means of pressure nozzles, one or more pressure nozzles being arranged on one side of the treated articles and a corresponding number of suction nozzles, which draw in the drying medium expelled from the pressure nozzles and return same to the heating and the pressure nozzles in the form of a cycle or convey the drying medium out of the drier, being arranged directly on the other side of the treated articles. In the case of printed circuit boards which have a large number of interfacial connection holes a relatively large amount of drying medium flows through these holes with a pressure/suction nozzle arrangement of this kind. Even liquid which has collected in these holes therefore evaporates rapidly.

Through the constant increase in packing density and in the miniaturisation of electronic components, printed circuit boards are correspondingly becoming ever thinner and more flexible. With conventional dryers these flexible printed circuit boards or printed circuit films can no longer be dried with the desired effectiveness, because such treated articles are deflected or bent, and pressed against nozzles and other components through the pressure generated on the treated article by the drying medium expelled by the nozzles used. This can cause damage to the treated articles. However, if the pressure is suitably reduced, the time needed for drying is considerably lengthened.

DE 1 142 065 AS discloses a through-type furnace for heat treating metal sheet or strip or similar flat articles, in which a gas cushion is generated by nozzles operating with controlled pressure in order to maintain the treated articles in a suspended state.

It is therefore an object of the present invention to provide a method and an apparatus for drying articles which have been treated, the method and the apparatus also being suitable for effectively drying very thin and therefore delicate articles which have been treated.

This object is achieved by a method according to claim 1 and an apparatus according to claim 5. The dependent claims define advantageous or preferred embodiments of the method and the apparatus.

It is proposed according to the invention to transport the articles which have been treated along a transport path and to impel thereon a first stream from above and a second stream from below of a gaseous drying medium at at least one location on the transport path, a first pressure associated with the first gas stream and a second pressure associated with the second gas stream being detected and the first gas stream being regulated in dependence on the first pressure and the second gas stream in dependence on the second pressure. Through such separate regulation of the first and second gas streams acting from above and from below on the treated articles, it can be achieved that even thin treated articles are not bent and preferably are maintained in suspension.

Furthermore, a temperature control for the first and/or second gas stream may be provided. For this purpose fan means are activated appropriately to generate the first and/or second gas stream and/or the regulation of the first and/or second gas stream is changed.

To direct the first gas stream and the second gas stream on to the treated articles, a first and a second gas outlet device are provided.

A desired reference pressure for the first and second gas outlet devices can be determined before the start of production for a particular type of article treated.

In this case the gas outlet devices may be in the form of nozzles which include, for example, a nozzle plate extending transversely over the full width of the transport path and arranged parallel to the transport path, nozzle apertures being provided in the nozzle plate to allow the gaseous drying medium to pass through. The nozzle apertures may be in the form of elongated slits or in the form of a row of bores. A plurality of rows of nozzle apertures may also be provided in the direction of the transport path.

In addition, gas guidance elements, e.g. metal plates, may be provided to prevent or at least impede the lateral escape of the gaseous drying medium.

To regulate the first and/or second gas stream, regulating means, e.g. in the form of flaps or valves, may be provided in feed lines to the gas outlet devices. Sensor means for detecting the respective pressures are then preferably arranged between the regulating means and the gas outlet devices.

For transporting the treated articles along the transport path, transport means may be provided which include rollers arranged above and below the transport path and driveable for transporting the treated articles. Preferably no rollers are arranged between the first and second gas outlet devices, in order to enable an unimpeded gas flow. However, the first and second gas outlet devices may have in their edges recesses for rollers directly adjacent to them in order to prevent the treated articles from being pressed against the gas outlet devices.

The apparatus is preferably accommodated in a housing in which, in particular, an outlet line for discharging the gaseous drying medium is provided.

More than one pair of first and second gas outlet devices may, of course, be provided to ensure efficient drying as the treated articles pass through the apparatus.

For the drying of thick treated articles the possibility may be provided to reverse the direction of either the first or the second gas flow. This may be determined, in particular, automatically, in dependence on a thickness of the treated article, which is determined, for example, by sensor means.

The gaseous drying medium is thus impelled against the treated articles from one side and extracted from the other side. In this case even liquid located in holes in the thick treated articles is reliably and rapidly dried, while thin treated articles continue to be dried by being blown upon from both sides.

The invention therefore provides a possibility of reliably and gently drying treated articles of varying thicknesses without manual intervention and without interrupting production.

The invention is elucidated in more detail below with reference to a preferred embodiment and to the appended drawings, in which:

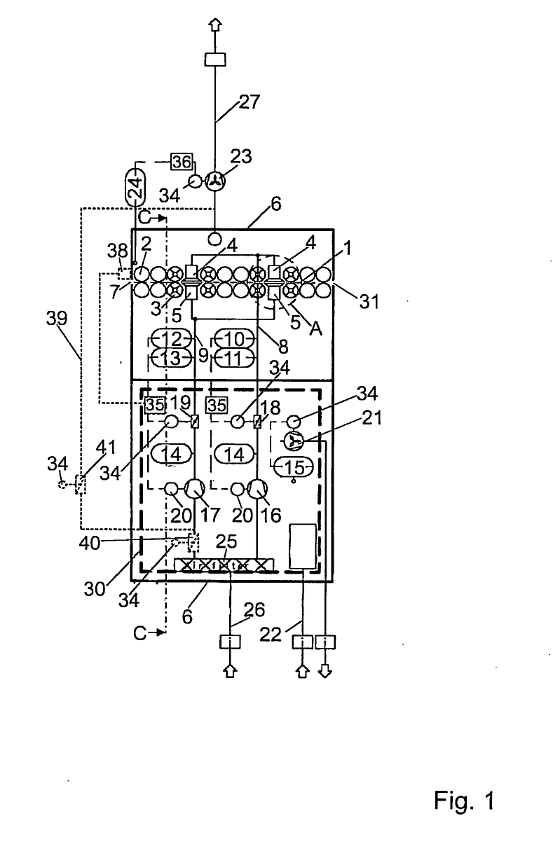

FIG. 1 is a schematic side view of an embodiment of an apparatus according to the invention;

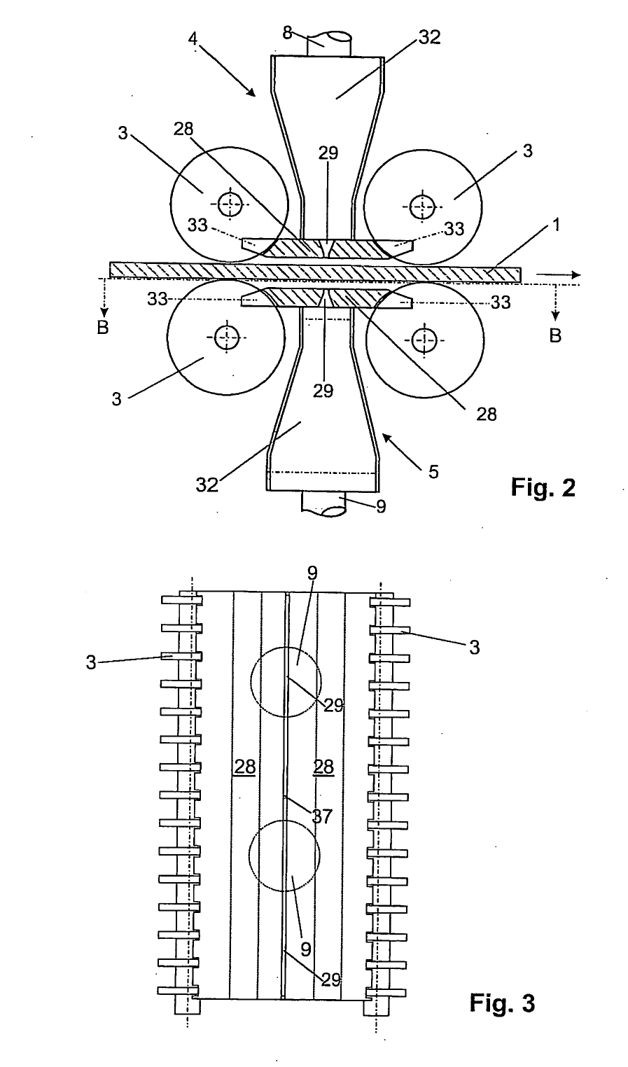

FIG. 2 is a detail view of a section A of FIG. 1 in elevation;

FIG. 3 is a plan view of the section from FIG. 2, and

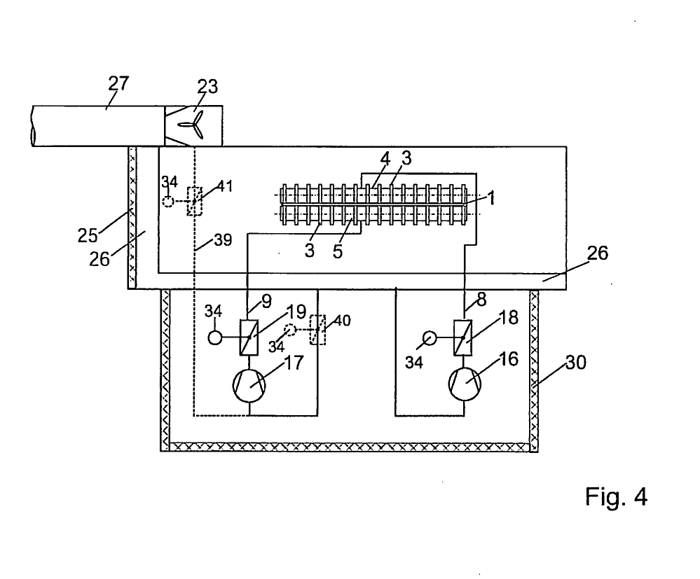

FIG. 4 is a schematic sectional representation along a line C-C of the apparatus according to the invention of FIG. 1, showing a possible spatial arrangement of the elements.

FIG. 1 shows schematically the structure and interaction of different components of a drier according to the invention. This drier includes a two-part housing 6, compressed air fans 16, 17 being provided in the lower part of the housing 6, which fans 16, 17 supply nozzles 4 and nozzles 5, called pressure nozzles, separately with compressed air, which in this case serves as the drying medium. The nozzles 4 and 5 are located in the upper part of the housing 6. The nozzles 4 are arranged above a transport path which extends from the entry opening 7 to an exit opening 31 of the housing 6, while the nozzles 5 are arranged below this transport path. A nozzle 4 and a nozzle 5 are located in each case opposite one another in such a way that their outlet apertures face towards one another. In the present embodiment two pairs of nozzles 4, 5 are illustrated; however, more such pairs or only one pair may be present.

Located in the lower part of the housing 6 are regulating means 18 and 19, for example, flaps, such as motorised throttle flaps, or valves which can be actuated by means of actuators 34 and thus can regulate the flow of gas from the fans 16, 17 to the nozzles 4, 5. To convey the treated articles through the drier, rollers in the form of cylinders 2 and wheels 3, between which the treated articles are driven forwards, are provided in the upper part of the housing 6. A treated article 1 is thus moved continuously from the entry opening 7 to the exit opening 31 past the nozzles 4 and 5. As this happens compressed air is blown on to the treated article from above and below. With appropriately set pressure the treated article is maintained as if in suspension. Through this measure bending and therefore damage is prevented, in particular in the case of thin treated articles.

To accelerate drying, additional outlet nozzles (not shown) may be provided which, as already stated in the introduction to the description, impel cold gas under pressure obliquely against the treated articles and thus displace and/or atomise a certain portion of a liquid adhering to the treated article.

Provided in compressed air feed lines 8, 9 leading from the fans 16, 17 to the nozzles 4, 5 are temperature sensors 11, 13 and pressure sensors 10, 12 for separate detection of the pressure and temperature of the drying medium in the feed lines 8 and 9. The values determined are continuously acquired and processed by control means 35. A separate control unit 35 may be provided—as illustrated—for each compressed air fan. However, a single central control unit, located e.g. inside a computer system present for other control functions, is also suitable. In accordance with the values detected the rotational speed of the compressed air fans 16, 17 is varied via a drive motor 20 and a speed control 14, and the settings of the regulating means 18 and 19 are changed. By opening the regulating means 18 and 19 the pressure can be increased. To increase the temperature, the speed of the corresponding fan 17 or 16 is, for example, increased, and at the same time the corresponding regulating means somewhat closed, in order to maintain the same pressure. The drying medium is, however, more strongly compressed, causing a rise in temperature. To lower the pressure or to reduce the temperature the respective inverse operation is carried out.

In traditional driers a suitable gas heater is provided to control the temperature of the drying medium. However, such temperature control can only be used with suitably heat-resistant treated articles, since drying is carried out with very high temperatures. The temperature is preferably controlled to a value at which rapid drying is ensured while, on the other hand, the treated articles are not damaged.

In the present embodiment air which is drawn in through an inlet duct 26 is used as the drying medium. In addition, a filter 25 in the form of a filter mat is provided to remove contaminants from the air which might otherwise cause contamination of the treated articles.

In addition, a pressure sensor 24 is arranged in the upper part of the housing 6. By means of the pressure values determined via this pressure sensor 24, the speed of an evacuation fan 23 is controlled, with which evacuation fan 23 used drying medium is removed from the housing and the pressure in the upper part of the housing 6, the so-called working cell, is maintained constant at a predetermined article-specific value. By means of this speed-controlled evacuation fan 23 extraneous gases containing e.g. corrosive substances from other processes, which, through unfavourable pressure conditions in an evacuation duct 27, have been conducted into the same evacuation duct, are prevented from entering the working cell of the drier. Such gases might otherwise cause etching or contamination of the treated articles 1. The evacuation fan 23 is controlled with a further actuator 34 and a control unit 36.

A temperature sensor 15 is also arranged in the lower part of the housing 6 is via which temperature sensor 15 a supply of cooling air for the fans 16, 17 is controlled via a cooling air intake duct 22 and a cooling air discharge fan 21.

FIG. 2 shows a much enlarged section A from FIG. 1, while FIG. 3 shows a cross-sectional view along a line B-B of FIG. 2.

FIG. 2 shows the treated article 1 passing between the nozzles 4 and 5, which treated article 1 is conveyed between the nozzles 4, 5 at a uniform speed by the transport wheels 3 arranged to the left and right of the nozzles 4, 5. The nozzle 4 is arranged above the transport path of the treated article 1 and the nozzle 5 below same. One or more tubular feed lines 8 lead to the nozzle 4, and one or more feed lines 9 for the drying medium lead correspondingly to the nozzle 5. A distributor duct 32 makes the drying medium available over the full length of the corresponding nozzle 4 or 5, transversely to the transport path. The nozzles 4 and 5 are closed off by nozzle plates 28 in which nozzle outlet apertures 29 are located. As can be seen in FIG. 3, the outlet apertures 29 are configured as elongated slits interrupted by a narrow bridge 37 to increase stability. Instead of the elongated slits, rows of bores are possible, and a plurality of such slits or rows of bores may be arranged side-by-side. In this case the bridges 37 are preferably arranged offset to one another.

The transport wheels 3 engage in recesses 33 in the nozzle plates 28. By means of these recesses and the transport wheels 3 engaging therein the front edge of a very thin treated article 1 is prevented from colliding with the nozzle plate as it runs in.

An air cushion which maintains the treated articles in suspension between the two nozzle plates 28 is formed by the gas flow expelled from the nozzles. This cushion is not yet so strongly formed in the run-in area, but the transport wheels 3 engaging in the nozzle plate 28 prevent the treated articles from catching on the nozzle plate.

If thin as well as thick treated articles are to be dried with the drier, a thickness sensor 38—represented by a broken line in FIG. 1—which is connected to control means 35 of a nozzle, may be additionally provided at the entry opening 7.

For the drying of thicker treated articles, for example, having a thickness greater than 0.2 mm, the gas flow of the drying medium will be reversed in the two nozzles 5 without manual intervention, so that the nozzles 4 impel drying medium against the treated articles and the nozzles 5 arranged on the opposite side extract the drying medium again. Through the high pressure difference drying medium is conveyed even through the bores in thick treated articles and the liquid in the bores is thus dried more rapidly. No risk of damage to the treated articles exists in this case because thick, solid treated articles cannot be bent by the streaming gas flow. To produce the inverse gas flow the direction of rotation of the fan 17 of the gas supply 9 is reversed, so that a partial vacuum is produced. In this case a tubular branch conduit 39 (also represented by a broken line) with throttle flap is preferably provided between the intake line for the drying medium and the outlet line, which opens into the evacuation duct 27, or a connecting line between evacuation fan and drier housing. Also for this purpose, a non-return flap or non-return valve 40 is present in an intake line of the fan 17 with reversed feed direction, to prevent an escape of used drying medium from the suction line into intake duct 26, which could lead, for example, to suction of the used drying medium through the fan 16. When thick articles are being treated, a valve 41 is opened while the non-return valve 40 is closed. This makes it possible to dispose in a conventional manner of the used drying medium sucked from the treated articles.

It may also be provided, of course, that the gas flow through the nozzles 4 is reversed instead of the gas flow through the nozzles 5.

Apart from the automatic reversal by means of the thickness sensor, a manual switch-over is also possible in principle.

An arrangement of the thickness sensor 38 directly before the nozzles 4, 5 is likewise possible, or the thickness of the treated articles 1 may be transmitted to the drier from a preceding process step, for example, electroplating, or it may be detected in another way.

FIG. 4 shows a section through a drier according to the invention in a front view, which corresponds substantially to a section along a line C-C from FIG. 1. In this view the treated articles move into the drawing plane through the entry opening (not shown) and leave the drier again through the exit opening (also not shown). Located in the lower part of the drier housing are the fans 16, 17 for the upper and lower nozzles 4, 5, which are not shown in this representation. Also arranged in the lower part of the housing are the motor-driven throttle flaps 18, 19. Because of the high noise emission of the fans 16, 17, the wall of the housing 6 is provided in the lower part with sound insulation 30. In this case the intake duct 26 for fresh drying medium, for example air, is arranged between the lower and upper parts of the drier housing. The intake duct opens at the side of the housing upstream of the above-mentioned filters 25. This arrangement of the intake duct 26 makes it possible to realise large filter mat areas for the intake of fresh air without substantial additional space requirement. The intake duct 26 itself also receives a large cross-section through this arrangement. The fans 16, 17 then draw in the air for drying the treated articles 1 from the intake duct 26, the pipes provided for this purpose being shown as lines.

The evacuation fan 23, which evacuates used air from the upper part of the housing, is installed above the upper part of the drier housing. The evacuation fan 23 is connected to the evacuation duct 27, which leads into the open air, for example, via air washers located downstream.

The elements 39, 40 and 41 provided for the above-described additional operating mode for drying thick treated articles are again represented by broken lines.

### List of Reference Numerals

1 Treated articles
2 Transport rollers
3 Transport wheels
4 Upper compressed air nozzles
5 Lower compressed air nozzles
6 Drier housing
7 Entry opening
8 Upper drying medium feed line
9 Lower drying medium feed line
10 Upper pressure sensor
11 Upper temperature sensor
12 Lower pressure sensor
13 Lower temperature sensor
14 Compressed air fan speed control
15 Fan housing temperature control
16 Upper compressed air fan
17 Lower compressed air fan
18 Upper motorised throttle flap
19 Lower motorised throttle flap
20 Speed-regulated drive motor
21 Cooling air discharge means (fan)
22 Cooling air intake
23 Evacuation fan
24 Drier housing pressure sensor
25 Fresh air filter mat
26 Fresh air intake duct
27 Evacuation duct
28 Nozzle plate
29 Nozzle outlet aperture
30 Sound insulation
31 Exit opening
32 Distributor duct
33 Recess
34 Actuator
35 Control means
36 Control means
37 Bridge
38 Thickness sensor
39 Outlet line
40 Non-return valve
41 Valve

1. Method for drying articles which have been treated (1),
the treated articles (1) being transported along a predefined transport path,
a gaseous drying medium being blown onto the treated articles (1) with a first gas stream from above and with a second gas stream from below,
the first gas stream and the second gas stream being regulated in feed lines to respective gas outlet devices,
characterised in that the treated articles are continuously conveyed in along the transport path for drying and conveyed out after drying,
a temperature of the first and/or second gas stream is detected, and
fan means (16, 17) for generating the first and/or second gas stream are controlled in such a way that the temperature detected is regulated to a predefined value.

2. Method according to claim 1, characterised in that the first and second gas streams are regulated in such a way that the treated articles are maintained in suspension at the at least one location.

3. Method according to claim 1, characterised in that for temperature regulation a rotational speed of the fan means is changed by control of the fan means (16, 17).

4. Method according claim 1, characterised in that a thickness of the treated article (1) is detected and in that a direction of either the first gas stream or the second gas stream is reversed if the thickness of the treated article (1) exceeds a predefined thickness.

5. Method according to claim 1, characterised in that the first gas stream and/or the second gas stream are regulated by a pressure regulation.

6. Method according to claim 5, characterised in that a first pressure associated with the first gas stream and a second pressure associated with the second gas stream are detected in the respective feed line from the fan means (16, 17) to the respective gas outlet device for pressure regulation.

7. Method according to claim 1, characterised in that the treated article is a plate-like article.

8. Apparatus for drying articles which have been treated (1),
comprising
transport means (2, 3) for transporting the treated articles (1) along a predefined transport path,
a first (4) and a second (5) gas outlet device which are arranged above and below the transport path and which each have at least one gas outlet aperture (29) facing towards the transport path, and
fan means (16, 17) for supplying a gaseous drying medium to the first and to the second gas outlet device via a respective first (8) and second (9) feed line,
there being associated with each of the first and second gas outlet devices (4, 5) regulating means (18, 19) in the respective feed line (8, 9) for regulating a gas flow of the gaseous drying medium through the respective gas outlet device (4, 5), and
control means (35) being provided which are so configured that they control the regulating means (18, 19) for regulating the gas flow through the respective gas outlet device (4, 5),
characterised in that the transport means (2, 3) are designated such that they continuously convey the treated articles, (1) along the transport path into the apparatus for drying and out of the apparatus after drying,
at least one temperature sensor (11, 13) is provided for detecting a temperature of the respective gas flow, and
the control means are configured to control the fan means (16, 17) in such a way that the temperature detected by the at least one temperature sensor (11, 13) is regulated to a predefined value.

9. Apparatus according to claim 8, characterised in that the first and second gas outlet devices (4, 5) include gas guidance elements which are arranged adjacent to the respective at least one gas outlet aperture (29).

10. Apparatus according to claim 8, characterised in that the first and second gas outlet devices (4, 5) are in each case configured in the form of a nozzle.

11. Apparatus according to claim 10, characterised in that the nozzle (4, 5) includes a nozzle plate (28) which extends transversely to the transport path over its full width and is arranged parallel to the transport path, nozzle apertures (29) being provided in the nozzle plate (28) to allow the gaseous drying medium to pass through.

12. Apparatus according to claim 11, characterised in that the nozzle apertures (29) include elongated slits.

13. Apparatus according to claim 11, characterised in that the nozzle apertures (29) include bores arranged in a row transversely to the direction of the transport path.

14. Apparatus according to claim 11, characterised in that at least two rows of nozzle apertures (29) are arranged side-by-side in the direction of the transport path.

15. Apparatus according to claim 8, characterised in that the regulating means (18, 19) include a flap which is arranged in the first (8) or second (9) feed line such that the respective feed line (8, 9) is at least partially closable with the flap.

16. Apparatus according to claim 8, characterised in that the regulating means (18, 19) include a valve.

17. Apparatus according to claim 8, characterised in that pressure sensor means (10, 12) are arranged between the respective regulating means (18, 19) and the gas outlet devices (4, 5) for detecting a pressure generated by the respective gas flow, the control means (35) controlling the regulating means (18, 19) in dependence on the pressure detected by the respective pressure sensor means (10, 12).

18. Apparatus according to claim 8, characterised in that the transport means include rollers (2, 3) which are arranged above and below the transport path and are driveable to transport the treated articles (1).

19. Apparatus according to claim 18, characterised in that no rollers (2, 3) are arranged between the first gas outlet device (4) and the second gas outlet device (5).

20. Apparatus according to claim 18, characterised in that the first and second gas outlet devices (4, 5) each have recesses (33) for the rollers (3) in edges arranged transversely to the direction of the transport path.

21. Apparatus according to claim 8, characterised in that the apparatus includes a closed housing (6) which surrounds the apparatus and has an entry opening (7) for introducing the treated articles (1) and an exit opening (31) for discharging the treated articles (1).

22. Apparatus according to claim 21, characterised in that an evacuation duct (27) is provided to evacuate the gaseous drying medium from the housing (6).

23. Apparatus according to claim 22, characterised in that
extraction means (23) are associated with the evacuation duct (27),
further pressure sensor means (24) are arranged in the housing (6) at a distance from the gas outlet devices (4, 5), and
the control means (36) are configured to control the extraction means (23) in such a way that a pressure detected by the further pressure sensor means (24) is maintained at a constant predefined value.

24. Apparatus according to claim 21, characterised in that the housing (6) includes a first and second housing part, the transport means (2, 3) and the first (4) and second (5) gas outlet devices being accommodated in the first housing part and the fan means (16, 17) and the regulating means (18, 19) being accommodated in the second housing part (6).

25. Apparatus according to claim 24, characterised in that there is provided an intake duct (26) for fresh gaseous drying medium arranged between the first and second housing parts.

26. Apparatus according to claim 8, characterised in that at least one temperature sensor (11, 13) and at least one gas heating means are arranged in the first (8) or second (9) feed line, and the control means are configured to control the gas heating means in such a way that the temperature detected by the at least one temperature sensor is regulated to a predefined value.

27. Apparatus according to claim 8, characterised in that the apparatus includes at least two pairs of first (4) and second (5) gas outlet devices.

28. Apparatus according to claim 8, characterised in that the apparatus is configured for drying plate-like treated articles (1).

29. Apparatus according to claim 8, characterised in that means (38) for detecting a thickness of the treated articles (1) are provided, and the control means (35) are so configured that they control the fan means (16, 17) to reverse the gas flow either through the first gas outlet device (4) or through the second gas outlet device (5) if the thickness of the treated articles exceeds a predefined thickness.

30. Apparatus according to claim 29, characterised in that the means for detecting the thickness of the treated articles (1) include sensor means (38) for determining the thickness of the treated articles (1).

31. Apparatus according to claim 8, characterised in that the apparatus is configured for carrying out the method according to claim 1.
